(19) United States
(12) Patent Application Publication
(10) Pub. No.: US 2007/0132847 A1
(43) Pub. Date: Jun. 14, 2007

(54) System of adult verification in mobile RFID environment and method thereof

(76) Inventors: Young Soo Kim, Daejeon-city (KR); Nam Je Park, Daejeon-city (KR); Taek Yong Nam, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/598,361

(22) Filed: Nov. 13, 2006

(30) Foreign Application Priority Data
Dec. 9, 2005 (KR) 10-2005-0120994

(51) Int. Cl. H04N 7/18

(52) U.S. Cl. 348/143

(57) ABSTRACT

A system for adult verification in a mobile RFID environment and a method thereof, more particularly, a system which strongly protects privacy and a method thereof are provided. The system comprising a RFID tag, a user terminal, an adult verification request processor, and a content provider (CP) includes: a rating information reader reading adult verification rating information of adult content recorded in an RFID tag; an adult verification rating determiner determining a final rating of the read rating information; and a service rating verification validity checker determining whether the adult content corresponding to the final rating is provided to a user of the terminal on the basis of the determined final rating and the age of the user.

### CROSS-REFERENCE TO RELATED PATENT APPLICATION

This application claims the benefit of Korean Patent Application No. 10-2005-0120994, filed on Dec. 9, 2005, in the Korean Intellectual Property Office, the disclosure of which is incorporated herein in its entirety by reference.

### BACKGROUND OF THE INVENTION

1. Field of the Invention

The present invention relates to a system of adult verification in a mobile RFID environment and a method thereof, and more particularly, to a system which strongly protects privacy and a method thereof.

2. Description of the Related Art

Users of mobile RFID networks wishing to access an adult content service at present need to go through an adult verification process prior to using the desired adult content service. The adult verification process is as follows. First, when the user selects the adult content menu through the mobile terminal, a warning message is displayed on the terminal screen of the mobile terminal. The user inputs the last 7 digits of their social identification (ID) number, and then the mobile carrier compares stored user information with the input social ID number and proceeds to identify the user as an adult. When the user is identified, a password input window appears on the terminal screen of the mobile terminal. The user can then access the adult content if the password input is correct.

In this method of adult verification, since the adult verification is achieved through direct use of the mobile terminal, minors can access adult content without control when they are aware of the social ID number of the official user and have access to the mobile terminal. For example, a teenager may attempt to use his or her parents' mobile terminal to access adult content. In addition, since the user's social ID number is required, threats to maintaining the privacy of the personal information of the user may be serious.

Also, the present rating system of multimedia content including adult content is currently divided into three categories based on the user's age: M-rating, R-rating, and X-rating. When these simple ratings are applied to the mobile RFID services, it is expected that a rating value be recorded in a user data region of a RFID tag. However, to protect the minors from harmful materials, more detailed ratings are needed.

### SUMMARY OF THE INVENTION

According to an aspect of the present invention, there is provided a system for adult verification in mobile RFID environment having an RFID tag, a user terminal, an adult verification request processor, and a contents provider (CP), the system including: a rating information reader reading adult verification rating information of adult content recorded in an RFID tag located in a user terminal; an adult verification rating determiner determining a final rating of the read rating information; and a service rating verification validity checker determining whether the adult content corresponding to the final rating is provided for a user of the terminal on the basis of the determined final rating and an age of the terminal user.

According to another aspect of the present invention, there is provided a method of adult verification in mobile RFID environment, the method including: (a) reading adult verification rating information of adult content recorded in an RFID tag by a user terminal; (b) determining a final rating of the read rating information; and (c) determining whether the adult content corresponding to the final rating is provided for a user of the terminal on the basis of the determined final rating and an age of the terminal user.

### BRIEF DESCRIPTION OF THE DRAWINGS

The above and other features and advantages of the present invention will become more apparent by describing in detail exemplary embodiments thereof with reference to the attached drawings in which:

FIG. 1 shows a block diagram of a network environment for employing the present invention;

FIG. 2A is a block diagram showing a system of adult verification including elements, according to an embodiment of the present invention;

FIG. 2B is a flowchart showing a method according to an embodiment of the present invention; and

FIGS. 3A through 3E are charts for explaining rating information of adult verification, according to an embodiment of the present invention.

### DETAILED DESCRIPTION OF THE INVENTION

Hereinafter, a preferred embodiment according to the present invention will be described in detail with reference to the accompanying drawings.

The present invention provides a system of adult verification in a mobile RFID environment and a method thereof in which the privacy of personal information can be maintained when a user undergoes adult verification needed for accessing adult content.

The present invention also provides a system for adult verification in a mobile RFID environment and a method thereof in which rating classifications of adult content is subdivided so that minors can be effectively protected from accessing adult content.

Hereinafter, the present invention will be described in detail by explaining exemplary embodiments of the invention with reference to the attached drawings. Like reference numerals in the drawings denote like elements. If necessary, elements of different drawings may be referred to when the corresponding drawing is explained.

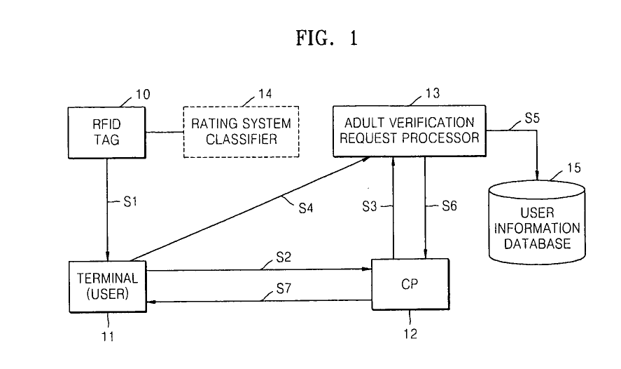

FIG. 1 shows a block diagram of a network environment for employing the present invention.

Referring to FIG. 1, the network environment for employing the present invention includes an RFID tag 10, a user terminal 11, a content provider (CP) 12, and an adult verification request processor 13.

The processes of the present invention in the aforementioned network environment are summarized as follows.

The user terminal 11 reads application data (adult verification rating information) indicating the rating recorded in a user region of the RFID tag 10 (S1).

The user terminal 11 requests the adult verification from the CP 12 (S2).

The CP 12 redirects the request to the adult verification request processor 13 to process the adult verification (S3).

The user terminal 11 logs into the adult verification request processor 13 using an ID dedicated to the adult verification, that is an ID for connecting to the adult verification request processor 13 (S4). Then, it is assumed that the user has previously registered in the adult verification request processor 13.

The adult verification request processor 13 refers to a user information database 15 and extrapolates the age of the user from the social ID number of the user (S5).

The adult verification request processor 13 determines whether the user is permitted to have access to the adult content in reference to the extrapolated age of the user and the value of each category of the adult verification rating information and provides the determination result for the CP 12 (S6). The present invention is embodied by allowing the CP 12 to provide or not to provide the adult content to the user terminal 11 corresponding to the determination result.

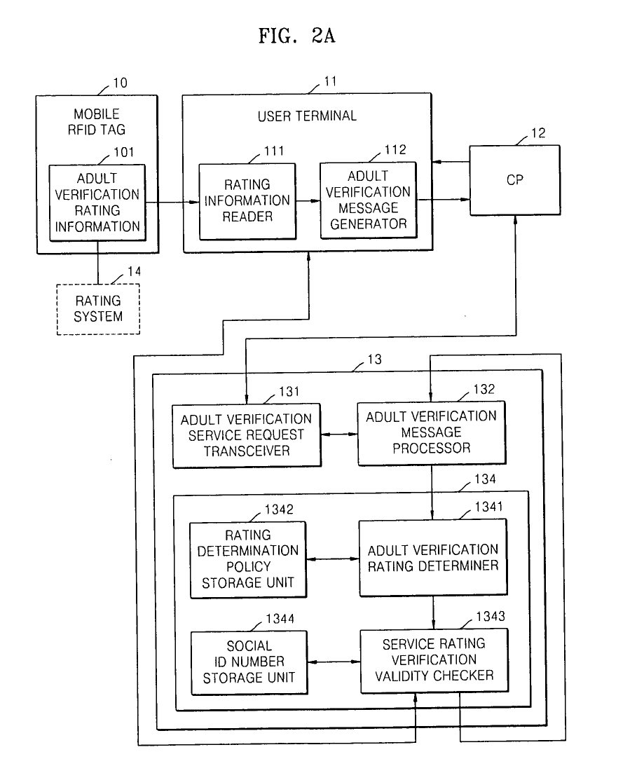

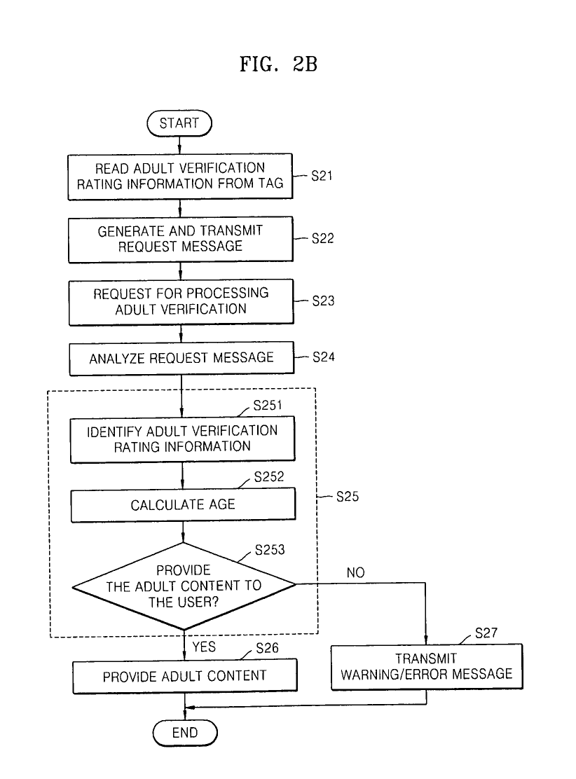

FIG. 2A is a block diagram showing a system of adult verification including elements, according to an embodiment of the present invention. FIG. 2B is a flowchart showing a method according to an embodiment of the present invention.

The system of adult verification in a mobile RFID environment according to an embodiment of the present invention includes function modules of the user terminal 11, the CP 12, and function modules of the adult verification request processor 13.

The function modules of the user terminal 11 include a rating information reader 111 and an adult verification message generator 112. The function modules of the adult verification request processor 13 includes an adult verification service request transceiver 131, an adult verification message processor 132, and a user age identifier 134.

When the rating information reader 111 included in the user terminal 11 reads the adult verification rating information 101 recorded in the RFID tag 10 (S21), the adult verification message generator 112 generates an adult verification request message (inquiry message) including the RFID tag ID and the adult verification rating information and transmits the adult verification request message to the CP 12 (S22).

The CP 12 redirects the adult verification request message to the adult verification request processor 13 and requests the adult verification request processor 13 to process the adult verification (S23). The adult verification service request transceiver 131 receives the message and transmits the message to the adult verification message processor 132. The adult verification message processor 132 analyzes the adult verification request message (S24), acquires each category value of the adult verification rating information included in the user data region, and transmits each acquired category value to the user age identifier 134. Then, each category value is recorded in the user data region of the RFID tag 10 according to the rating criteria for each category stored in a rating system classifier 14.

An adult verification rating determiner 1341 determines final ratings of the adult verification rating information according to the final rating determination policy of an adult verification rating determination policy storage unit 1342 (S251), and transmits the determined final rating and the tag ID to a service rating verification validity checker 1343.

When the service rating verification validity checker 1343 requests and receives an input of the ID dedicated to the adult verification from the user terminal 11, the service rating verification validity checker 1343 reads the social ID number of a specific person from a social ID number storage unit 1344 and calculates the age of the specific person (S252).

The service rating verification validity checker 1343 determines whether the CP 12 provides the corresponding adult content to the user using the determined final rating and the calculated age of the user (S253) and transmits the determination result to the adult verification message processor 132.

The adult verification message processor 132 notifies the CP 12 of the determination result through the adult verification service request transceiver 131. The CP 12 provides the corresponding adult content to the user terminal 11 (S26) or does not provide the adult content by transmitting a warning or error message to the user terminal 11 (S27).

The user undergoes the adult verification through the aforementioned processes and if successful receives the adult content. In the aforementioned processes, any privacy threat to the social ID number is not taken into account as it is assumed that the adult verification request processor 13 is a trusted third party (TTP). Since the user of the mobile terminal undergoes the adult verification through the dedicated ID stored in the adult verification request processor 13, the user can receive the adult content without the mobile terminal of the user and undergo the adult verification while maintaining the privacy of the social ID number of the user.

In addition, when a minor undergoes the adult verification using the personal information of a mobile terminal registrant registered in a mobile carrier, the chance that the minor passes the adult verification and gains access to the uncensored adult content when the minor has the mobile terminal of their parents and know the social ID numbers of their parents is eliminated.

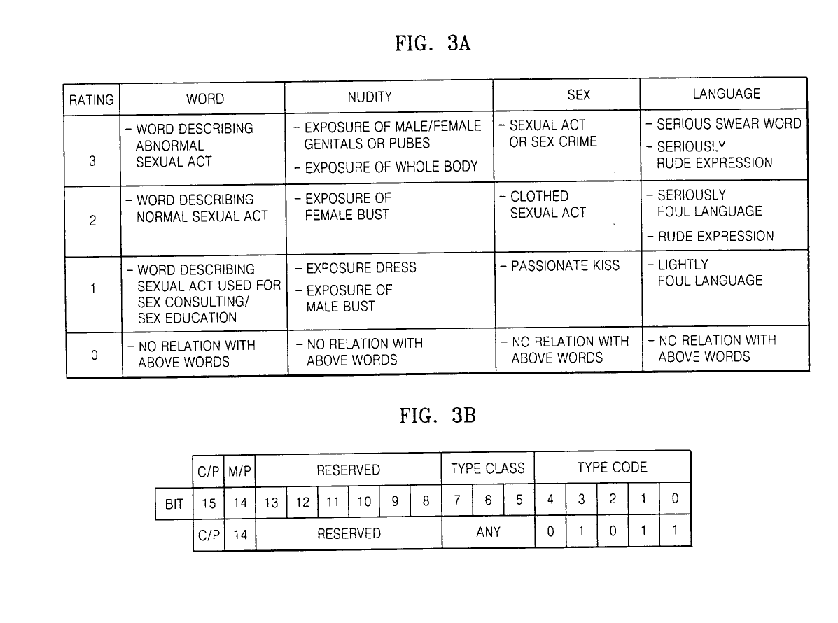

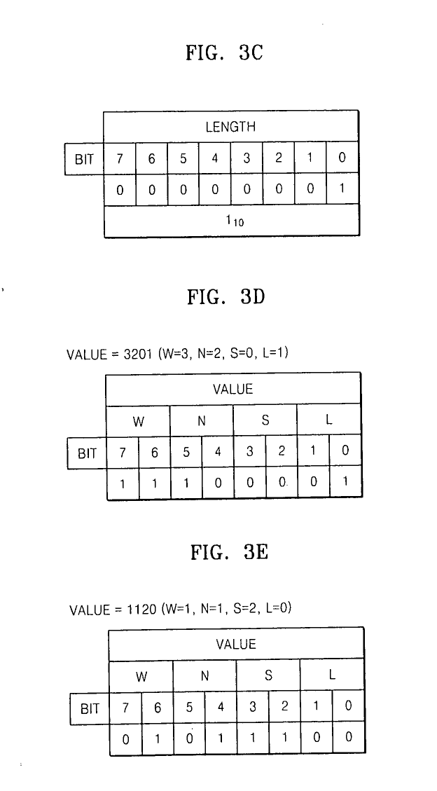

FIGS. 3A through 3E are charts for. explaining the rating information of the adult verification, according to an embodiment of the present invention.

To receive the adult content according to the present invention, as described above, the adult verification rating information 101 indicating the rating of the adult content is assigned to the user data region of the RFID tag 10.

The rating system classifier 14 employs four-level rating system (0 to 3) in detail, which is different from the conventional ratings based on ages. The adult content is classified based on each category (for example, swear word, nudity, sex, and foul language as shown in FIG. 3A) and the rating information gets assigned to the adult content based on each category. The rating information is assigned to the user data region of the RFID tag 10.

FIG. 3A shows the aforementioned rating criteria.

Content in which a word describing an abnormal sexual act is used, male/female genitals or pubes are exposed, a direct sexual act or sex crime is described, or outright foul language is used are rated 3. Content in which a normal sexual act description word is used, a female bust exposure picture, a clothed sexual act, or a serious swear word or rude expression is included are rated 2. Content in which a word describing a sexual act used for sex consulting/sex education is included or light foul language is used are rated 1. Content which is not included in the above cases are rated 0.

The rating system classifier 14 records the adult verification rating information assigned based on the four categories (for example, swear words, nudity, sex, and foul language) in the user data region of the RFID tag 10. The rating of multimedia content can be expressed with respect to each category using the detailed rating criteria. The weight factors may be differently applied to the categories such as swear words, nudity, sex, and foul language, according to applications.

In FIGS. 3B through 3E, specific examples of the adult verification rating expression are suggested.

\textcircled{1}TYPE

A TYPE field represents the user data region. Expression format of the adult rating stored in the user data region is defined in the standards of the mobile RFID application data format. In a structure of TYPE-LENGTH-VALUE (TLV), the TYPE value shown in FIG. 3B is included.

Both COMMON and PRIVATE can be assigned to the C/P bit according to the codes included in the tag, products about the code, or kinds of services. Since the adult rating does not include other application data in a VALUE field, an M/P bit is set to MONO. TYPE CLASS may be a product/service and TYPE CODE may be an original code of the product/service.

\textcircled{2}LENGTH

A LENGTH field represents length of the user data region, and the value of the adult rating application data allocated to the user data region of the RFID tag 10 can be an integer from 0000(000000002) to 3333(111111112), the length of the LENGTH field is expressed in 8 bits. Accordingly, the value of the LENGTH field is set to a byte value of 110 and expressed in 8 bits as shown in FIG. 3C.

\textcircled{3}VALUE

A VALUE field represents a practical adult rating with respect to the mobile RFID service and is expressed in integer values. The range of the VALUE field is from 0000 to 3333. As shown FIGS. 3D and 3E, two bits are assigned to swear words W, nudity N, sex S, and foul language L, respectively. A variety of methods of mapping the values of the VALUE field to the adult criteria are available.

In FIGS. 3D and 3E, examples of the value fields are expressed in the rating expression according to the definition of the mobile RFID application data format standards. FIG. 3D is a case where the value of VALUE field is 3201. FIG. 3E is a case where the value of VALUE field is 1120.

For example, in a case where a value of W is 1, a value of N is 1, a value of S is 2, and a value of L is 0, the corresponding final rating may be 2, which is the maximum value, or 1, which is equal to two of the four values. In addition, when the different weight factors are allocated to categories W, N, S, and L, respectively, according to the application, the final rating is determined based on the corresponding weight factor policy. In other words, methods of rating the adult content can be diversified by allocating the weight factors to items W, N, S, and L, respectively.

In the rating expression method, the adult content can be expressed with various ratings by allocating the content ratings to fields including swear words W, nudity N, sex S, and foul language L, respectively. In addition, the adult rating can be adjusted according to the applications. For example, 0 to 1 ratings may be classified as non-harmful contents, and 2 to 3 ratings may be classified as harmful contents. In other case, only 3-rating may be treated as the adult content. In addition, the final rating can be adjusted by changing the weight factors allocated to the swear word, the nudity, the sex, and the foul language according to the application. In the rating allocation policies, for example, the highest value of the ratings allocated to W, N, S, and L is determined as the final rating. Therefore, the rating allocation policies can be diversified.

According to the present invention, the user can receive the adult content without the terminal of the user and undergo the adult verification while maintaining the privacy of the social ID number. In addition, when a minor undergoes the adult verification using the personal information of a mobile terminal registrant registered in a mobile carrier, the minor cannot pass the adult verification and gain access to the uncensored adult content even when the minor has the mobile terminal of their parents and know the social ID numbers of their parents. In addition, according to the rating expression method of the present invention, the content can be expressed with a wider variety of ratings by allocating content ratings to categories including swear words, nudity, sex, and foul language, respectively. In addition, the adult rating can be adjusted according to the application and can be applied to various applications.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims.

The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system of adult verification in a mobile RFID environment, the system comprising:
a rating information reader reading adult verification rating information of adult content recorded in an RFID tag located in a user terminal;
an adult verification rating determiner determining a final rating of the read rating information; and
a service rating verification validity checker determining whether the adult content corresponding to the final rating is provided to a user of the terminal on the basis of the determined final rating and age of the user.

2. The system of claim 1, further comprising a rating system classifier classifying the adult content on the basis of each category and storing the rating information for each item, wherein the adult verification rating information is acquired from the rating system classifier and is recorded in the RFID tag.

3. The system of claim 2, wherein the rating system classifier assigning the final rating by allocating weight factors to each category thereof.

4. The system of claim 1, further comprising a storage unit storing a rating determination policy for determining the final rating, wherein the adult verification rating determiner determines the final rating of the read adult verification rating information in reference to the storage unit.

5. The system of claim 1, wherein a social ID number of the user is stored in the system and the service rating verification validity checker receives an ID dedicated to the adult verification from the user terminal , calculates the age of the user on the basis of the social ID number of the user corresponding to the ID dedicated to the adult verification, and performs the determining on the basis of the age and the determined final rating.

6. A method of adult verification in a mobile RFID environment, the method comprising:
(a) reading adult verification rating information of adult content recorded in an RFID tag by a user terminal;
(b) determining a final rating of the read rating information; and
(c) determining whether the adult content corresponding to the final rating is provided to a user of the terminal on the basis of the determined final rating and age of the user.

7. The method of claim 6, further comprising (d) classifying the adult content on the basis of a plurality of categories and storing the rating information for each category, wherein the adult verification rating information is recorded in the RFID tag with respect to the categories.

8. The method of claim 7, wherein the final rating is assigned by allocating weight factors to each category.

9. The method of claim 7, further comprising (e) storing a rating determination policy for determining the final rating, wherein (b) is performed in reference to the rating determination policy.

10. The method of claim 6, wherein in (c), the determining is performed by receiving an ID dedicated to the adult verification from the user terminal and calculating the age of the user on the basis of the social ID number of the user corresponding to the ID dedicated to the adult verification.
